(19) United States
(12) Patent Application Publication
(10) Pub. No.: US 2007/0116048 A1
(43) Pub. Date: May 24, 2007

(54) SYSTEMS AND METHODS FOR NEXT GENERATION CABLE NETWORK DYNAMIC MULTIPLEXING

(75) Inventor: Timothy Addington, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: TANDBERG Television Americas, Duluth, GA (US)

(21) Appl. No.: 11/278,325

(22) Filed: Mar. 31, 2006

Related U.S. Application Data
(60) Provisional application No. 60/672,581, filed on Apr. 18, 2005.

(51) Int. Cl. H04J 3/22

(52) U.S. Cl. 370/468; 370/535

(57) ABSTRACT

An intelligent multiplexer is disclosed for multiplexing various types of traffic on a cable network. The multiplexer receives information regarding the traffic currently provided, or anticipated to be provided, including the associated bandwidth and dynamically allocates bandwidth for the various traffics types as required. A rules database may be consulted to determine how the re-allocation of traffic data is to occur. In this manner, flexibility is provided for accommodate various service demands and more efficiently using network resources.

### RELATED APPLICATIONS

This application claims the benefit of U.S. provisional patent application No. 60/672,581, filed on Apr. 18, 2005.

### FIELD OF THE INVENTION

The present invention generally pertains to cable network technology, particularly to adaptive and dynamic multiplexing techniques for traffic on a cable network.

### BACKGROUND

Cable networks transmit a plurality of video and other type of information streams using a transmission network. These networks were traditionally based on coaxial transmission technology, but more and more such networks are based on fiber optic technology and use SONET or ATM based techniques. The transmission networks originally provided a unidirectional communication medium with video information transmitted from the headend to the set top box, but cable networks are now bi-directional communication networks. However, even with bi-directional networks, most of the information (in terms of utilized and allocated bandwidth) is transmitted from the headend to the set top box in the form of video information streams.

Regardless of the actual transmission facility used, there is a finite amount of bandwidth available on the transmission network components to accommodate the services. Although improvements in technology are increasing the overall amount of information that can be transmitted (e.g., many current cable systems can provide hundreds of video channels), the total amount of bandwidth is limited and the relative amounts of bandwidth allocated for each type of service is fixed—e.g., static.

Cable network operators are also augmenting the services they provide. In addition to basic service, most cable networks provide movies on demand, pay-per-view channels, in addition to high-speed Internet access. Many other types of services are possible, but the bandwidth requirements of all the services must not exceed the capability of the facilities. Further, it is desirable to use the existing facilities in the most efficient manner.

To illustrate the principles of the present invention, four main services are illustrated, although in practice, more exist. These include:
1) Movies on Demand (MOD). This service allows the user to select one from a plurality of movies to view at the present. The user typically signals the network from the set top box, and the network downloads the appropriate information allowing the set top box to decode the information.
2) Broadcast Basic Video. This provides a variety of local or national channels to the user on a continuous basis. No special signaling is required to receive these channels in this embodiment as the channels are continuously made available.
3) Data Services (High Speed Data). This service provided bi-directional, high-speed data transfer, which is typically used by users for browsing the world wide web.
4) Signaling. In order to obtain the MOD, as well as allow the network to administer and manage the other services, signaling must be able to be transferred between the headend and the user's set top box.

An arrangement for allocating the bandwidth for these services is illustrated at a high level in FIG. 1. In FIG. 1, the fiber 120 represents the transmission facility, which has a finite bandwidth and is illustrated conceptually by the size of the fiber or “pipe.” The fiber must convey a variety of information streams, and these are represented as smaller bandwidth streams or “pipes.” For example, the movies on demand service 114 is shown as an aggregate bandwidth 114 over which individual movies 112 are streamed. The operator has allocated a certain aggregate bandwidth for MOD, and thus only a defined number of movies 112 can be streamed over the maximum bandwidth 114 allocated for MOD. While a given user in a household is typically only watching one movie, other subscribers on the network may be doing so. Thus, the total number of users able to simultaneously view a movie on demand is limited by the bandwidth allocated for the service.

Similarly, the cable operator also allocates a certain amount of bandwidth 110 for broadcast video channels 108. In this case, the bandwidth allocated usually is the same as the number of channels transmitted, as the channels are typically continuously transmitted. However, in certain cases, some channels may be transmitting programs for only limited hours during the day. For example, certain channels may not carry programming in the early morning hours. Alternatively, the channels may be carrying “filler” programs (e.g., “infomercials”) because the channel bandwidth cannot be used for other purposes. However, generally speaking, the bandwidth allocated for broadcast basic video correlates with the maximum number of channels, which is typically the same number of channels being broadcasted at any given time.

The bandwidth allocated for signaling 106 is typically smaller in comparison to the previously mentioned services, as the traffic requirements for signaling traffic 104 are less. The signaling channel allocation depends in part on the other types of service allocated. In this simple example, if no movies on demand were offered, the signaling channel 106 would be allocated a smaller bandwidth.

Finally, a certain amount of bandwidth 102 is allocated for high speed data traffic 100. Such traffic is typically representative of users browsing the world-wide-web, which represents bi-directional traffic.

The image of FIG. 1 is a simplified illustration of the relative sizes of bandwidth allocated for various services on a cable transmission network and how they are used to convey specific instances of traffic. The current practice statically defines the allocated bandwidth for each service grouping based on best estimates of usage, traffic patterns and volumes, and profitability. One factor included considered include the allocated number of maximum channels that are distributed (whether based on analog or digital transmission). The remaining bandwidth is then divided with a portion allocated to MOD. Typically, the bandwidth allows a maximum number of requests to be handled. Next, a portion of the bandwidth, albeit small, is allocated for signaling applications. Then, whatever bandwidth is left over may be allocated for Internet (data) based traffic.

The network architecture to accommodate this fixed allocation of bandwidth resources is shown in FIG. 2, depicting the VOD QAM equipment 200, the Switched Video Broadcasts 202, the Broadcast Channels, High Speed Data traffic 206, and Signaling Data 208. Each of this is allocated a fixed amount of bandwidth on a static basis corresponding to each of the “pipes” of FIG. 1.

### BRIEF DESCRIPTION OF THE DRAWINGS

FIG. 1 discloses a prior art method of bandwidth allocation for types of traffic in a cable distribution network.

FIG. 2 discloses a prior art method of a network architecture for providing multiple services in a cable network.

FIG. 3 discloses one embodiment according to the present invention of dynamically allocating bandwidth traffic types in a cable network.

FIG. 4 discloses one embodiment according to the present invention of a network architecture for providing dynamic bandwidth allocation in a cable network

### DETAILED DESCRIPTION

Static allocation of bandwidth for different types of services is the current practice for allocating bandwidth on a cable network. This requires the operator to define the bandwidth allocation, and periodically review the allocation with respect to services and usage. Typically, the cable operator has various sub-networks, and the bandwidth for each must be periodically reviewed and reallocated similarly. If a new service is to be offered, a certain amount of bandwidth must be allocated to it and the cable provider must either allocate unused bandwidth, or more likely, reallocate the bandwidth among existing service types. Obviously, matching the available resource (bandwidth) to the needs for the resources (services) is time consuming, error prone, and subject to estimation. While having a surplus of bandwidth to allocate facilitates the allocation process and provides a ‘cushion’ against errors, maintaining a surplus of bandwidth is inefficient, and represents unrealized revenue potential. Further, a surplus of bandwidth cannot be presumed to always exist. If sufficient additional bandwidth is available, then adding the new service is possible without altering existing allocations and reallocation is not necessary.

However, with the increasing number of channels, the increase in new features, the available bandwidth for adding new services is limited. Given that many new service opportunities exist and cable operators desire to add these to their cable network, a more flexible bandwidth allocation scheme is needed for managing new and existing services.

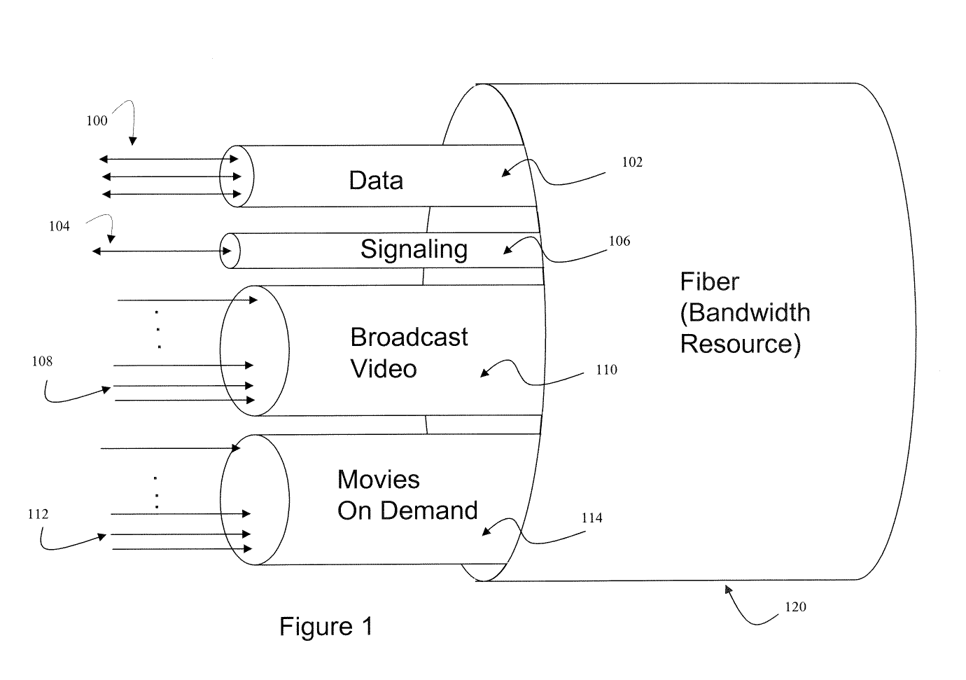

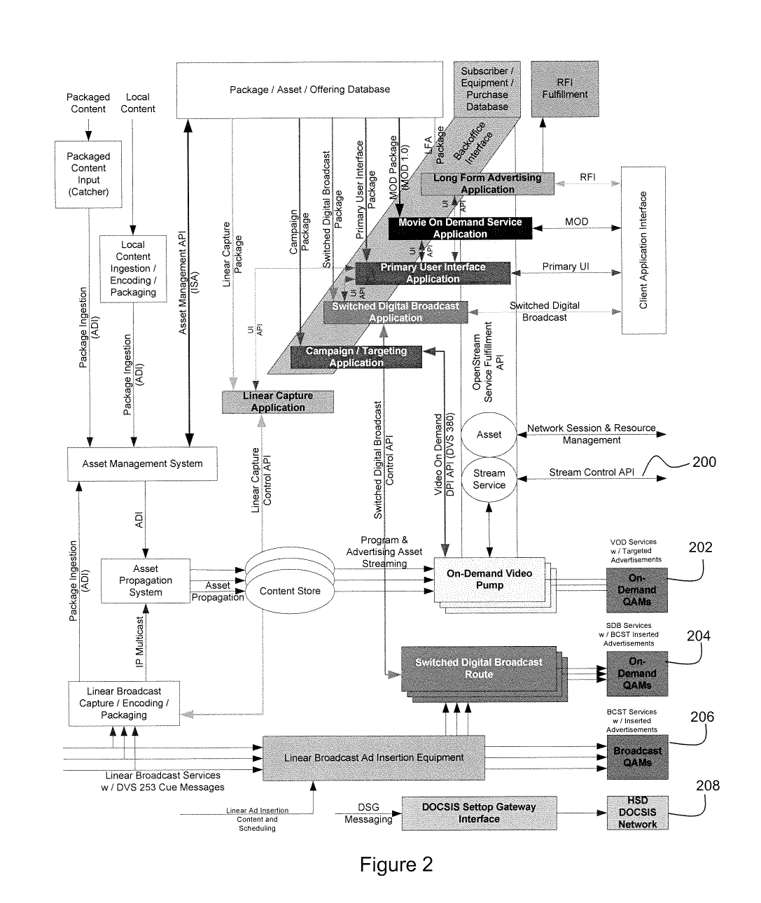

The fundamental scheme currently in practice is illustrated in FIGS. 1 and 2. In FIG. 1 illustrates one allocation that a cable operator may make for resource allocation for different services. In FIG. 1, the fiber 120 represents finite bandwidth allocated to accommodate the services for all times. The services disclosed are exemplary, as there may be more of less. FIG. 1 represents a fixed bandwidth for high speed data 102, which may include a number of active connections, such as TCP/IP connections 100. Similarly, there is a fixed bandwidth allocated for broadcast video 110, which comprises a number of channels 108. Similarly, there is a signaling channel 106 conveying signaling information 104 between the hosts and the network. Finally, there is a finite bandwidth allocated for movies on demand 114 that can handle a maximum of a certain number of movies 112.

Currently, the allocation of bandwidth is static, and the associated architecture is shown in FIG. 2. In FIG. 2, each of the bandwidths is allocated and must convey the required traffic. For example, in FIG. 2, the High Speed DOCSIS network traffic 208 is allocated a bandwidth 102 of FIG. 1 that conveys all the high speed data traffic 100 of FIG. 1. The bandwidth allocated is sized based on the current/projected subscriber basis. Similarly, the Stream Control 200 of FIG. 2 represents signaling traffic between the hosts and the cable network, and it corresponds to the signaling traffic 104 shown in FIG. 1 conveying aggregate signaling traffic 104. Similarly, there is a static amount of bandwidth allocated to broadcast traffic 206, switch digital video 204, and video on demand traffic 202. (Note all of these have a corresponding bandwidth shown on FIG. 1). FIG. 2 illustrates that the equipment used to multiplex the traffic is allocated a bandwidth that is independent from other traffic. Further, each of the QAMs in FIG. 2 may manage its bandwidth, for example to accommodate insertion of advertising information. Again, the allocation of traffic within a QAM is not coordinated in real time with that of the others.

As expected, the service mix, and thus the allocated bandwidth, may vary over the course of the day, or the day of the week. For example, a cable operator may find the demand for MOD increases significantly on weekend nights, or based on the popularity of the movies being offered. Similarly, the data traffic (e.g. Internet) may increase during the week, but drop off during weekends.

In addition to a time based metric, the demographics of the serving area may impact the service mix relative to other serving areas. Certain areas may see a larger percentage of data traffic, and a lower demand for broadcast video. Other areas may not see a large demand for movies on demand. Areas with large number of families with school age children may use the Internet for school work during the week after school, whereas other areas having fewer such families may not have the same demand. Thus, a cable network operator may desire to alter the allocation of bandwidth resources based on a specific geographical area. For example, one portion of a serving area may have one type of traffic allocation whereas serving area may have a different traffic allocation scheme. The allocation of bandwidth to various services types requires periodic adjustments.

While traffic allocation may be done manually by the cable operator based on changing subscriber demographics or growth factors, the readjustment is error prone. If too much traffic is allocated to high speed data unnecessary, users may be adversely impacted when selecting video on demand services at certain times. For optimal efficiency, the re-allocations should be done in real time, but this is not manually possible.

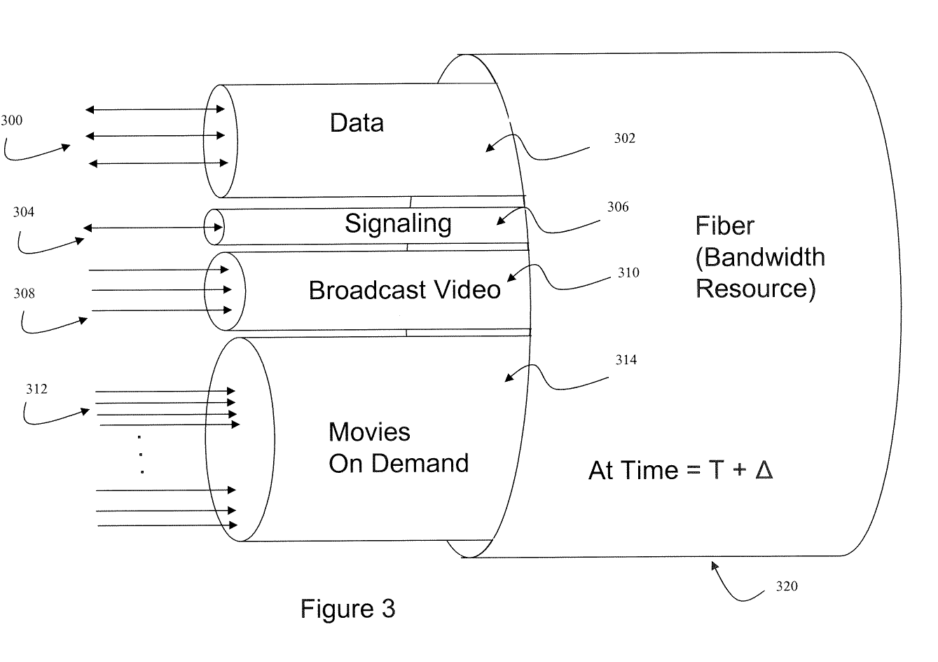

The concept of dynamic allocation of bandwidth is shown in FIG. 3. In FIG. 3, the relative bandwidths allocated for the services is different compared to FIG. 1. Further, the relative bandwidths allocated for the service may vary over time. Thus, FIG. 3 illustrates the bandwidth allocation of the same cable network at a time=T+Δ. The reason for the difference in allocated bandwidth is that in some servicing areas, there may be a greater than expected demand for movies on demand (MOD), and thus the bandwidth allocated 314 for MOD is greater, in order to accommodate the increased number of simultaneous movies 312. Similarly, there may be a need for fewer broadcast video channels 308. The number required may vary based on the time of day, or based on the particular market which the cable network is serving. The signaling bandwidth 306 is illustrated as the same, while the bandwidth allocated 302 for data is larger, based on the increased number of Internet based connections 300.

The ability to intelligently and dynamically control the various information streams (whether video or otherwise) being transmitted from the headend over the cable network impacts the operation of the equipment in the network. The equipment must be able to receive or provide information regarding bandwidth resources required or consumed. In order to provide the flexibility and greater efficiency, the cable network must now be able to provide the information streams using a dynamically allocated bandwidth scheme.

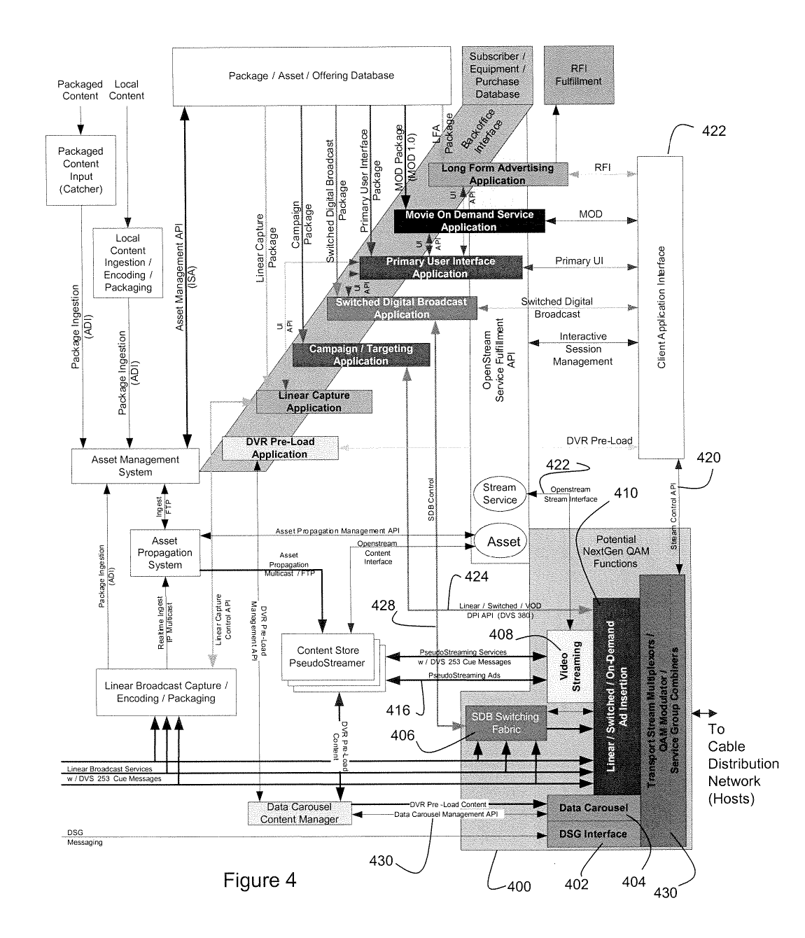

This is accomplished by using an intelligent multiplexer, (a.k.a. a “Next Generation QAM or “NexGen QAM”) 400 shown in FIG. 4. The NexGen QAM is able to receive information regarding required bandwidth, and dynamically adjust the allocation of bandwidth for services as appropriate. Further, by placing the intelligent QAM multiplexer at the edge of the network, the allocation of traffic to the needs of the hosts connected to the network can be better accommodated for the distribution network. Further, by multiplexing the different types of traffic closer to the edge of the network, the various disparate network components handling each of the traffic types are isolated to a greater extent from the aggregate traffic. In essence, multiplexing the differing stream at the edge of the network frees up to a degree, the traffic allocation of the traffic types prior to the multiplexing. It also provides a single point of coordination of bandwidth allocation between the different traffic types.

In FIG. 4, the NexGen QAM 400 receives two types of traffic. First, it receives the traffic to be multiplexed to the hosts. Second, it receives signaling information about the traffic to be sent to the host. By receiving signaling information about each traffic type, NexGen QAM 400 is able to know how to allocate traffic, based on current request and current traffic allocations. Thus, the NexGen QAM 400 receives information about establishment request of DOCSIS HSD as well as the data itself. Consequently, the NexGen QAM 400 is shown as encompassing the Settop Gatewasy (DSG) interface 402 conveying high speed data between the user's and the Internet (not shown). The high speed data is typically bi-directional, and its bandwidth requirements is directly related to the number of subscribers able to access HSD services.

The NexGen QAM also multiplexes signaling data that is carouseled to the hosts. The data carousel 404 handles the distribution of software updates and download commands to hosts as necessary. Typically, the volume required for this traffic type is not that large. In some embodiments, this allocation may be static, however, if a large number of downloads are necessary, there may be motivation to adjust the bandwidth allocated. Of course, dynamic allocation of bandwidth by the NexGen QAM 400 requires signaling protocols to the host to inform them of the reallocations as necessary.

The NexGen QAM also incorporates multiplexing of Switched Digital Broadcasting channels 406, which represent video streams. The bandwidth allocated is directly proportional to the number of video streams conveyed. Similarly, video streams are received by the Video Streaming component 408 and conveyed to the NexGen QAM. The video streams and switched digital channels may have advertisements dynamically inserted, so that the QAM has a component 410 for receiving ad insertion traffic. The NexGen QAM 400 not only receives the ad traffic 416, but the signaling information as to how and when the traffic is to be inserted.

As indicated, the NexGen QAM is required to know about which traffic types are required to be transported, as well as their characteristics. Consequently, the NexGen QAM receives inputs about the traffic. For example, inputs 420 are received from the Client Application Interface 422 regarding requested user services. This provides information to the NexGen QAM about anticipated user bandwidth requirements (e.g., including ensuring that bandwidth is allocated for movies being requested by users for viewing). In addition, the NexGen QAM receives other information, such as information regarding other video streams 422, switched digital control messages 428, carousel data 430, etc.

The NexGen QAM monitors data inputs impacting the relative allocation of the information streams with respect to the bandwidth resources being managed. Thus, NexGen QAM receives inputs comprising the status of the current services being requested by users, the current services being provided, as well as accessing various rules defined by the cable operator governing the allocation of services to resources. For example, even if a large number of users request a movie at a particular time, there may be a maximum number that may be allowed based on various rules so as to provide a guaranteed minimum service level. Specifically, the operator may desire to reserve certain bandwidth levels for high speed data usage, so that even if bandwidth or resources are available for additional movies, the number of movies would still be limited.

The inputs of the various traffic types are provided to the Transport Stream Processor (also called the Transport Stream Multiplexer or TSM) 430 which is a sub-component of the NexGen QAM. The TSM is the ‘gatekeeper’ for determining which streams are presented to users. The TSM selectively allocates each of the inputs to the allocated bandwidth and grooms the input streams for transport. The TSM may also re-code and/or encrypt the data prior to transmission.

Although FIG. 4 discloses various resources as included in the NexGen QAM, other embodiments may selectively separate some of the components. Thus, in certain embodiments, only NexGen QAM 400 may comprise only the TSM. However, the other components would still be tightly coupled with the TSM. There is an advantage to incorporating some of the components with the TSM, such as the switching fabric, video streaming, data carousel, etc. This allows faster and closer coordination of the traffic types between the TSM and the resource.

The TSM also logically serves as the point in which ad streams are inserted into transmissions. By placing the insertion of ad information as close as possible to the transmission stream, the ads can be tailored for the local market. Ad insertions may be inserted using a variety of techniques and inserted into a variety of the input streams.

Similarly, the TSM may receive data corresponding to Video on Demand (or Movies on Demand), and can further provide local buffering of the data. By allowing the TSM to ‘pull’ data from a source and buffer it, the video source is no longer required to provide a tightly synchronized data stream. Rather, this functionality is provided by the TSM when traffic is multiplexed onto the cable network. This approach reduces, to an extent, the need for a highly synchronized collection of devices, and focuses the synchronization functionality in the TSM.

Finally, the TSM is the logical point to also groom and insert switched digital broadcasting, local channels, etc. The TSM may also receive streams, buffer and convert (transcode) the video data as necessary.

The incorporation of the TSM allows the other network elements to provide data as non-streamed data, and localize the functions of grooming the final aggregate information stream at the edge of the network. By doing so, greater flexibility is afforded as to how the sources can be combined in an area to form the final aggregate information stream. This provides greater control and flexibility to cable operators as well.

The TSM typically maintains a database, or other memory store, with an indication of the maximum bandwidth available, as well as available bandwidth currently allocated for different types of services. Upon receiving a service request or other information regarding a traffic type, the TSM ascertains the available capacity currently allocated, and determines whether additional bandwidth is to be allocated to a service type, and whether it is available. The appropriate modifications to the maximum bandwidth available are made, as well as to any other allocations of bandwidth to service types. In addition, to ascertain the associated bandwidth for the request, the TSM may consult various rules indicating limits for traffic types, or access historical trends, including those based on time-of-day, day-of-week, to determine how bandwidth is to be allocated. Thus, minimum or maximum bandwidth thresholds may be defined so that limits may not be exceeded. For example, the NexGen QAM 400 may police the allocated bandwidth so that regarding of the demand for video-on-demand movies, a minimum allocated of bandwidth must be reserved for high speed data users. In such cases, the NexGen QAM may generating a signaling indication (to the appropriate traffic source) that the request cannot be accommodated.

1. A multiplexing apparatus in a cable distribution network comprising:
a first traffic interface to a high speed DOCSIS-based component capable of receiving a first traffic data comprising high speed data traffic for transmission on the cable distribution network;
a first traffic signaling interface capable of receiving a first bandwidth indicator associated with the high speed data traffic;
a second traffic interface to a switched digital broadcast component capable of receiving a second traffic data comprising high speed data traffic for transmission on the cable distribution network;
a second traffic signaling interface capable of receiving a second bandwidth indicator associated with the switch digital broadcast traffic;
a third traffic interface to a video-on-demand component capable of receiving a third traffic data comprising video-on-demand traffic for transmission on the cable distribution network;
a third traffic signaling interface capable of receiving a third bandwidth indicator associated with the video-on-demand traffic; and
a traffic multiplexer receiving the high speed data traffic, the switched digital broadcast traffic, and the video-on-demand traffic, and generating a multiplexed traffic stream, the traffic multiplexer further re-allocating an available bandwidth for one of the high speed data traffic, the switch digital broadcast traffic, and the video-on-demand traffic in response to receiving one of the group of the first traffic bandwidth indicator, the second traffic bandwidth indicator, and the third traffic bandwidth indicator, wherein the re-allocation of bandwidth takes into account a total bandwidth level available for the multiplexed stream on a distribution facility of the cable distribution network.

2. The apparatus of claim 1 further comprising a database of rules used by the traffic multiplexer to determine the re-allocation of bandwidth involving at least one of the group of the first traffic data, the second traffic data, and the third traffic data.

3. The apparatus of claim 1 further comprising a fourth interface to a client application interface, capable of receiving an indication of a request by a user on the cable distribution network.

4. The apparatus of claim 3 wherein the traffic multiplexer further re-allocates bandwidth to at least one of the group comprising a first traffic data, the second traffic data, and the third traffic data in response to receiving the indication of the request.

5. The apparatus of claim 1 further comprising a buffer, the buffer storing at least one of the first traffic data, the second traffic data, or the third traffic data to facilitate synchronization of the multiplexed traffic stream.

6. The apparatus of claim 1 wherein the plurality of inputs further receives advertisement traffic and associated advertisement control information, the traffic multiplexer multiplexing the advertisement traffic with the switch digital broadcasting data in accordance with the advertisement control information.

7. The apparatus of claim 1 wherein the traffic multiplexer transcodes the switched digital broadcast traffic.

8. The apparatus of claim 1 where after re-allocation of the bandwidth, the traffic multiplexer informs a host on the cable distribution network of how to access one of the traffic types.

9. A method for multiplexing traffic at a traffic multiplexer in a cable distribution system comprising:
receiving switched broadcast traffic at the traffic multiplexer associated with a first bandwidth level;
receiving high speed data traffic at the traffic multiplexer associated with a second bandwidth level;
receiving video-on-demand traffic at the traffic multiplexer associated with a third bandwidth level;
multiplexing the switched digital broadcast traffic, the high speed data traffic, and the video-on-demand traffic at the traffic multiplexer to form multiplexed traffic for transmission on a cable distribution network;
receiving an indication of a requested increase in bandwidth associated from one of the group of switched broadcast traffic, the high speed data traffic, and video-on-demand traffic;
re-allocating the at least one of the bandwidth levels associated with first bandwidth level, the second bandwidth level, and the third bandwidth level respectively associated with the increase in bandwidth; and
multiplexing the switched digital broadcast traffic, the high speed data traffic, and the video-on-demand traffic at the traffic in accordance with the re-allocated bandwidth levels.

10. The method of claim 9 wherein traffic allocated for the high speed data is greater than a minimum threshold level.

11. The method of claim 9 wherein the indication of a requested increase in bandwidth is based on analyzing signaling requests from hosts attached to the cable network.

12. The method of claim 9 further comprising the step of accessing a rules database to determine whether a proposed increase in bandwidth to one of the group of the first bandwidth level, the second bandwidth level, and the third bandwidth level exceeds a defined level.

13. The method of claim 9 further comprising the step of:
transmitting signaling information to at least one host on the network to provide an indication of a reallocation of bandwidth for a type of traffic.

14. The method of claim 9 further comprising the step of:
updating a bandwidth allocation table maintained in a memory in the traffic multiplexer.

15. A computer readable medium comprising software for execution in a processor controlling a multiplexer to perform the steps of:
storing in memory a first bandwidth allocation for switched broadcast traffic received at a traffic multiplexer;
storing in the memory a second bandwidth allocation for high speed data traffic received at the traffic multiplexer; storing in the memory a third bandwidth allocation for video-on-demand traffic received at the traffic multiplexer;
receiving an indication of a requested increase in bandwidth associated from one of the group of switched broadcast traffic, the high speed data traffic, and video-on-demand traffic;
re-allocating the at least one of the bandwidth levels associated with first bandwidth level, the second bandwidth level, and the third bandwidth level respectively associated with the increase in bandwidth; and
multiplexing the switched digital broadcast traffic, the high speed data traffic, and the video-on-demand traffic at the traffic according to the reallocated bandwidth levels.

16. The computer executable software of claim 15 further comprising the step of:
updating a bandwidth allocation table in the memory based on the re-allocated bandwidth.

17. The computer executable software of claim 15 further comprising the step of:
accessing a rules database to determine limits on reallocating bandwidth for a traffic type.

18. The computer executable software of claim 15 further comprising the step of:
generating signaling information for transmission to at least one host on the network to provide an indication of a reallocation of bandwidth for a type of traffic.
